(19) United States
(12) Patent Application Publication
(10) Pub. No.: US 2023/0318158 A1
(43) Pub. Date: Oct. 5, 2023

(54) CYLINDRICAL BATTERY AND BATTERY MODULE

(71) Applicant: HONDA MOTOR CO., LTD., Tokyo (JP)

(72) Inventor: Toshiyuki ARIGA, Saitama (JP)

(21) Appl. No.: 18/179,390

(22) Filed: Mar. 7, 2023

(30) Foreign Application Priority Data
Mar. 29, 2022 (JP) 2022-054630

(51) Int. Cl. H01M 50/586; H01M 50/107; H01M 10/0587; H01M 50/152; H01M 50/593; H01M 50/531; H01M 50/193; H01M 50/186; H01M 50/213

(52) U.S. Cl. CPC H01M 50/586; H01M 50/107; H01M 10/0587; H01M 50/152; H01M 50/593; H01M 50/531; H01M 50/193; H01M 50/186; H01M 50/213

(57) ABSTRACT

Provided is a cylindrical battery including: a shaft core; a set of wound electrodes including an electrode stack wound on the shaft core; an exterior member surrounding the set of wound electrodes; a cap disposed at one axial end of the shaft core and electrically connected to one of the positive and negative electrodes; and an insulating member disposed between the exterior member and the cap, the cap having an outer diameter that is larger than the inner diameter of the exterior member and smaller than the outer diameter of the exterior member, the insulating member having an outer diameter larger than the outer diameter of the cap, the insulating member having a protrusion that is located more inside in the radial direction of the set of wound electrodes than the inner surface of the exterior member and protrudes toward the set of wound electrodes.

This application is based on and claims the benefit of priority from Japanese Patent Application No. 2022-054630, filed on 29 Mar. 2022, the content of which is incorporated herein by reference.

### BACKGROUND OF THE INVENTION

### Field of the Invention

The present invention relates to a cylindrical battery and a battery module.

### Related Art

In recent years, secondary batteries that contribute to energy efficiency have been researched and developed to ensure that more people have access to affordable, reliable, sustainable, and advanced energy.

Patent Document 1 discloses a process for manufacturing a cylindrical nickel-hydrogen secondary battery. Specifically, the process includes: inserting a stepped insulating ring into a bottomed cylindrical can through its top opening, the stepped insulating ring having a large-diameter top portion, a small-diameter foot portion, and an inner step portion, the bottomed cylindrical can containing a set of electrode sheets and an electrolytic solution; and placing the small-diameter foot portion of the stepped insulating ring onto the set of electrode sheets. The process further includes: placing a peripheral portion of a cover onto the step portion of the stepped insulating ring, the cover having a built-in safety valve, so that a sealing target area is formed in which a top opening inner wall of the bottomed cylindrical can, a peripheral wall of the large-diameter top portion of the stepped insulating ring, and a peripheral portion of the cover face one another; and swaging the sealing target area to form a sealed structure.
Patent Document 1: Japanese Unexamined Patent Application, Publication No. H09-134712

### SUMMARY OF THE INVENTION

There is, however, a need to reduce the risk of short-circuiting in such a process.

It is an object of the present invention to provide a cylindrical battery that can be manufactured by a process with a lower risk of short-circuiting.

An aspect of the present invention is directed to a cylindrical battery including: a shaft core; a set of wound electrodes including an electrode stack wound on the shaft core and including a positive electrode, a negative electrode, and an electrolyte provided between the positive and negative electrodes stacked; an exterior member surrounding the set of wound electrodes; a cap disposed at one axial end of the shaft core and electrically connected to one of the positive and negative electrodes; and an insulating member disposed between the exterior member and the cap, the cap having an outer diameter that is larger than the inner diameter of the exterior member and smaller than the outer diameter of the exterior member, the insulating member having an outer diameter larger than the outer diameter of the cap, the insulating member having a protrusion that is located more inside in the radial direction of the set of wound electrodes than the inner surface of the exterior member and protrudes toward the set of wound electrodes.

The shaft core may include a first electrically-conductive part, an insulating part, and a second electrically-conductive part arranged in its axial direction, and the insulating part may be disposed between the first and second electrically-conductive parts and joined to the first and second electrically-conductive parts.

The cylindrical battery may have a space filled with a sealing resin between the exterior member and the insulating member and may also have a space filled with a sealing resin between the cap and the insulating member.

The insulating member may further have a second protrusion that is located more outside in the radial direction of the set of wound electrodes than the cap and protrudes away from the exterior member.

The insulating member may further have a through hole passing through a space between the insulating member and the exterior member and another space between the insulating member and the cap.

The distance between the exterior member and the insulating member in the axial direction of the shaft core may be larger at a radially outer portion than at a radially inner portion in the radial direction of the set of wound electrodes.

The electrode stack may include a solid electrolyte layer provided between the positive and negative electrodes stacked.

Another aspect of the present invention is directed to a battery module including multiple cylindrical batteries, each of which is as defined above.

The present invention provides a cylindrical battery that can be manufactured by a process with a lower risk of short-circuiting.

### BRIEF DESCRIPTION OF THE DRAWINGS

FIG. 1 is a partially cut-out, cross-sectional, perspective view of a battery module according to an embodiment of the present invention;

FIG. 2 is a cross-sectional view of the cylindrical battery shown in FIG. 1; and

FIG. 3 is a partially enlarged view of a region of the cylindrical battery surrounded by the broken line in FIG. 1.

### DETAILED DESCRIPTION OF THE INVENTION

Hereinafter, embodiments of the present invention will be described with reference to the drawings.

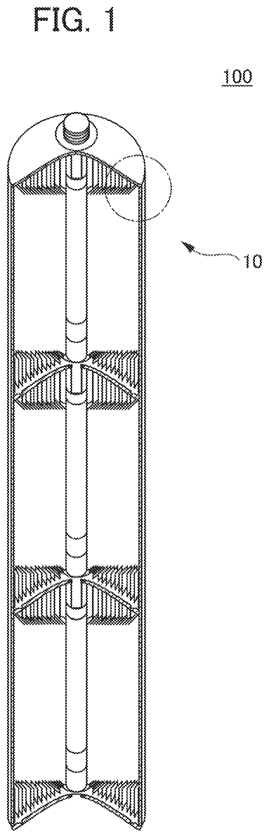

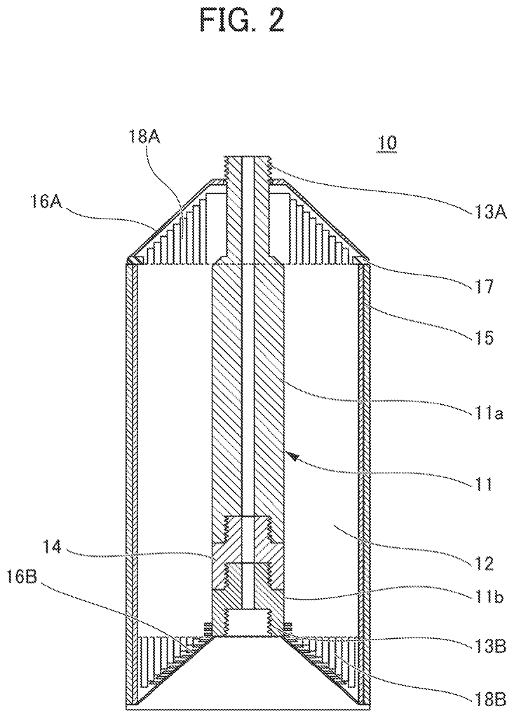

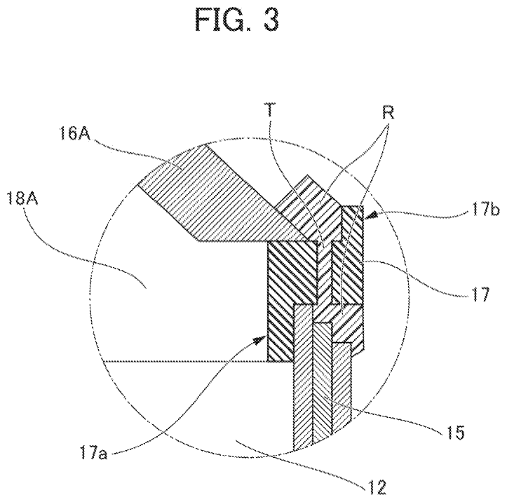

FIG. 1 shows an example of a battery module according to an embodiment of the present invention. FIG. 2 shows the cylindrical battery shown in FIG. 1. FIG. 3 shows a region of the cylindrical battery surrounded by the broken line in FIG. 1.

The battery module 100 includes multiple cylindrical batteries 10. The cylindrical batteries 10 each include: a shaft core 11; a set 12 of wound electrodes; an external thread 13A, which is a first fastener; and an internal thread 13B, which is a second fastener. The set 12 of wound electrodes includes an electrode stack including: a positive electrode, a negative electrode, and an electrolyte provided between the positive and negative electrodes stacked. The electrode stack is wound on the shaft core 11. The external thread 13A is provided at a first axial end (upper end) of the shaft core 11. The internal thread 13B is provided at a second axial end (lower end) of the shaft core 11. In the battery module 100, the cylindrical batteries 10 adjacent to each other are joined together with the external and internal threads 13A and 13B.

In this embodiment, the external thread 13A and the shaft core 11 are parts of a single piece. This feature provides a higher strength against the rotational torque for tightening the external thread 13A into the internal thread 13B. The external thread 13A is electrically connected to one of the positive and negative electrodes, and the internal thread 13B is electrically connected to the other of the positive and negative electrodes.

Alternatively, the first fastener may be an internal thread, and the second fastener may be an external thread.

The shaft core 11 includes a first electrically-conductive part 11a, an insulating part 14, and a second electrically-conductive part 11b, which are arranged in the axial direction. The insulating part 14 is disposed between the first and second electrically-conductive parts 11a and 11b and joined to the first and second electrically-conductive parts 11a and 11b. This feature allows an insulating member 17 to be compressed as described later and thus increases the sealing of the cylindrical battery 10. The internal thread is provided at the axial lower end of the first electrically-conductive part 11a. The insulating part 14 has an axial upper end, above which the external thread is provided, and has an axial lower end, below which the internal thread is provided. The external thread is provided at the axial upper end of the second electrically-conductive part 11b.

On the assembly of the first and second electrically-conductive parts 11a and 11b and the insulating part 14, the external and internal threads may be disposed at any locations that permit the insulating part 14 to be joined to the first and second electrically-conductive parts 11a and 11b.

Moreover, the second electrically-conductive part 11b may be integrated with a second cap 16B, which will be described later.

The first and second electrically-conductive parts 11a and 11b may be made of any suitable material, such as metal. The insulating part 14 may be made of any suitable material, such as polypropylene (PP), polyethylene (PE), polyethylene terephthalate (PET), polyphenylene sulfide (PPS), polytetrafluoroethylene (PTFE), PFA, or any other resin.

The electrode stack is in the form of a sheet, which includes electrodes each including an electrode current collector and an electrode material mixture layer provided on the electrode current collector. Specifically, the positive electrode includes a positive electrode current collector and a positive electrode material mixture layer provided on the current collector, and the negative electrode includes a negative electrode current collector and a negative electrode material mixture layer provided on the current collector. The electrolyte may be any type. For example, the electrolyte may be contained in an electrolytic solution with which a common porous resin membrane (separator) is impregnated or may be contained in a gel electrolyte layer, a solid electrolyte layer, or any other solid-state layer.

The electrode stack may have any stacked structure including a positive electrode, a negative electrode, and an electrolyte provided between the positive and negative electrodes. The electrode stack may include multiple positive electrodes and/or multiple negative electrodes. The stacked structure of the electrode stack including multiple positive electrodes and/or multiple negative electrodes may include, for example, a positive electrode, an electrolyte, a negative electrode, an electrolyte, and a positive electrode, which are stacked in order. The electrode stack may be produced, for example, by a roll pressing process.

The cylindrical battery 10 further includes an exterior member 15 surrounding the set 12 of wound electrodes. In this embodiment, the exterior member 15 is in the form of a sheet. The exterior member 15 may be made of any electrically-conductive material, such as metal.

In this embodiment, the exterior member 15 may be bonded with an adhesive to a distal end of the set 12 of wound electrodes, the distal end not being in contact with the shaft core 11, or the exterior member 15 may be an electrode current collector extending from a distal end of the set 12 of wound electrodes, the distal end not being in contact with the shaft core 11. This configuration provides an increased volumetric energy density for the battery module 100.

The set 12 of wound electrodes, surrounded by the exterior member 15, may be obtained by a process including winding the electrode stack and the exterior member 15 on the shaft core 11 while applying a certain tension to the electrode stack and the exterior member 15. In this process, pressure may be applied to the outside of the shaft core 11 while the electrode stack and the exterior member 15 are wound on the shaft core 11.

The cylindrical battery 10 further includes a first cap 16A and a second cap 16B. The first cap 16A is disposed at a first axial end (upper end) and electrically connected to one of the positive and negative electrodes. The second cap 16B is disposed at a second axial end (lower end) and electrically connected to the other of the positive and negative electrodes. In this embodiment, the first and second caps 16A and 16B each have a conical shape and a slope region that is substantially symmetrically inclined with respect to the shaft core 11. A ring-shaped insulating member 17 is disposed between the exterior member 15 and the first cap 16A. The first cap 16A is electrically connected to the external thread 13A, and the second cap 16B is electrically connected to the internal thread 13B and the exterior member 15.

The outer diameter of the first cap 16A is larger than the inner diameter of the exterior member 15 and smaller than the outer diameter of the exterior member 15. The outer diameter of the insulating member 17 is larger than the outer diameter of the first cap 16A. Moreover, the insulating member 17 has a first protrusion 17a that is located more inside in the radial direction of the set 12 of wound electrodes than the inner surface of the exterior member 15 and protrudes toward the set 12 of wound electrodes. Thanks to this configuration, short-circuiting is effectively prevented between the exterior member 15 and the first cap 16A during the process of manufacturing the cylindrical battery 10.

The space between the exterior member 15 and the insulating member 17 and the space between the first cap 16A and the insulating member 17 are filled with a sealing resin R. The resin R is, for example, a curable resin, such as a thermosetting resin or a photo-curable resin (e.g., UV (ultraviolet)-curable resin). This feature enables the insulating member 17 to be bonded between the exterior member 15 and the first cap 16A. Thus, short-circuiting is more effectively prevented between the exterior member 15 and the first cap 16A during the process of manufacturing the cylindrical battery 10.

The insulating member 17 also has a second protrusion 17b that is located more outside in the radial direction of the set 12 of wound electrodes 12 than the first cap 16A and protrudes away from the exterior member 15. Thanks to this feature, the sealing resin R is easily held in the process of filling the space between the first cap 16A and the insulating member 17 with the sealing resin R.

The insulating member 17 also has a through hole T that passes between the space between the insulating member 17 and the exterior member 15 and the space between the insulating member 17 and the first cap 16A. When poured into the space between the first cap 16A and the insulating member 17, therefore, the sealing resin R will fill the space between the exterior member 15 and the insulating member 17 and the space between the first cap 16A and the insulating member 17.

The distance between the exterior member 15 and the insulting member 17 in the axial direction increases stepwise as measured from inside to outside in the radial direction of the set 12 of wound electrodes. This feature ensures the space between the exterior member 15 and the insulating member 17, which is to be filled with the sealing resin R.

The distance between the exterior member 15 and the insulting member 17 in the axial direction may increase in any suitable manner, such as a linear manner, as long as it is larger at a radially outer portion than at a radially inner portion in the radial direction of the set 12 of wound electrodes.

The slope region of each of the first and second caps 16A and 16B may be inclined at any angle with respect to the shaft core 11. The angle at which the slope region of the first cap 16A is inclined with respect to the shaft core 11 is determined by the height of a proximal part of an extension portion 18A of the set 12 of wound electrodes and the width determined by the number of turns of the set 12 of wound electrodes, in which the proximal part of the extension portion 18A is adjacent to the shaft core 11. The slope region of the first cap 16A has a volume large enough to accommodate the extension portion 18A.

The first and second caps 16A and 16B may be made of any electrically-conductive material, such as metal. The first and second caps 16A and 16B may be made of the same material or different materials.

The insulating member 17 is compressed by the force exerted when the external thread 13A at the axial upper end of a shaft core 11 is tightened into the internal thread 13B at the axial lower end of another shaft core 11, so that the exterior member 15 and the first cap 16A are fixed and sealed. The second cap 16B and the exterior member 15 are joined at their contact portions by laser welding, so that they are integrated and sealed.

The insulating member 17 may be made of any suitable material, such as polypropylene (PP), polyethylene (PE), polyethylene terephthalate (PET), polyphenylene sulfide (PPS), polytetrafluoroethylene (PTFE), PFA, or any other resin.

The positive electrode current collector has an extension portion 18A extending from a first axial end (upper end) of the set 12 of wound electrodes. The negative electrode current collector has an extension portion 18B extending from a second axial end (lower end) of the set 12 of wound electrodes. In this embodiment, the extension portion 18A of the positive electrode current collector is electrically connected to the first cap 16A, and the extension portion 18B of the negative electrode current collector is electrically connected to the second cap 16B.

In this embodiment, the slope region of the second cap 16B electrically connected to the extension portion 18B for current collection to the exterior member 15 is inclined at a larger angle than the slope region of the first cap 16A electrically connected to the extension portion 18A for current collection to the shaft core 11. Thanks to this feature, adjacent cylindrical batteries 10 are easily joined together with the external and internal threads 13A and 13B.

Hereinafter, an example will be described in which the battery module according to an embodiment of the present invention includes cylindrical, all-solid-state, lithium secondary batteries.

The positive electrode current collector may be any suitable type, such as an aluminum foil.

The positive electrode material mixture layer includes a positive electrode active material and may further include a solid electrolyte, a conductive aid, a binder, and other optional materials.

The positive electrode active material may be any suitable material capable of storing and releasing lithium ions, examples of which include LiCoO₂, Li (Ni_{5/10}Co_{2/10}Mn_{3/10})O₂, Li (Ni_{6/10}Co_{2/10}Mn_{2/10})O₂, Li (Ni_{8/10}Co_{1/10}Mn_{1/10})O₂, Li (Ni_{0.8}Co_{0.15}Al_{0.05})O₂, Li (Ni_{1/6}Co_{4/6}Mn_{1/6})O₂, Li (Ni_{1/3}Co_{1/3}Mn_{1/3})O₂, LiCoO₄, LiMn₂O₄, LiNiO₂, LiFePO₄, lithium sulfide, and sulfur.

The solid electrolyte, which constitutes a solid electrolyte layer, may be any suitable material capable of conducting lithium ions, such as an oxide-based electrolyte, a sulfide-based electrolyte, or a molecular crystal electrolyte including crystals of an organic material with a dissociated electrolyte.

The negative electrode material mixture layer includes a negative electrode active material and may further include a solid electrolyte, a conductive aid, a binder, and other optional materials.

The negative electrode active material may be any suitable material capable of storing and releasing lithium ions, examples of which include metallic lithium, lithium alloys, metal oxides, metal sulfides, metal nitrides, Si, SiO, and carbon materials. Examples of the carbon materials include artificial graphite, natural graphite, hard carbon, and soft carbon.

The negative electrode current collector may be any suitable type, such as a copper foil.

The embodiments of the present invention described above are not intended to limit the present invention and may be altered or modified as appropriate without departing from the gist of the present invention.

### EXPLANATION OF REFERENCE NUMERALS

10: Cylindrical battery
11: Shaft core
11a: First electrically-conductive part
11b: Second electrically-conductive part
12: A set of wound electrodes
13A: External thread
13B: Internal thread
14: Insulating part
15: Exterior member
16A: First cap
16B: Second cap
17: Insulating member
17a: First protrusion
17b: Second protrusion
18A, 18B: Extension portion
100: Battery module
R: Resin
T: Through hole

What is claimed is:

1. A cylindrical battery comprising:
a shaft core;
a set of wound electrodes comprising an electrode stack wound on the shaft core and comprising a positive electrode, a negative electrode, and an electrolyte provided between the positive and negative electrodes stacked;
an exterior member surrounding the set of wound electrodes;
a cap disposed at one axial end of the shaft core and electrically connected to one of the positive and negative electrodes; and
an insulating member disposed between the exterior member and the cap,
the cap having an outer diameter that is larger than an inner diameter of the exterior member and smaller than an outer diameter of the exterior member,
the insulating member having an outer diameter larger than an outer diameter of the cap,
the insulating member having a protrusion that is located more inside in a radial direction of the set of wound electrodes than an inner surface of the exterior member and protrudes toward the set of wound electrodes.

2. The cylindrical battery according to claim 1,
wherein the shaft core comprises a first electrically-conductive part, an insulating part, and a second electrically-conductive part arranged in an axial direction, and
wherein the insulating part is disposed between the first and second electrically-conductive parts and joined to the first and second electrically-conductive parts.

3. The cylindrical battery according to claim 1, wherein the cylindrical battery has a space filled with a sealing resin between the exterior member and the insulating member and has a space filled with a sealing resin between the cap and the insulating member.

4. The cylindrical battery according to claim 3, wherein the insulating member further has a second protrusion that is located more outside in the radial direction of the set of wound electrodes than the cap and protrudes away from the exterior member.

5. The cylindrical battery according to claim 3, wherein the insulating member further has a through hole passing through a space between the insulating member and the exterior member and another space between the insulating member and the cap.

6. The cylindrical battery according to claim 3, wherein the distance between the exterior member and the insulating member in an axial direction of the shaft core is larger at a radially outer portion than at a radially inner portion in the radial direction of the set of wound electrodes.

7. The cylindrical battery according to claim 1, wherein the electrode stack includes a solid electrolyte layer provided between the positive and negative electrodes stacked.

8. A battery module comprising a plurality of the cylindrical batteries according to claim 1.
